(19) United States
(12) Patent Application Publication
(10) Pub. No.: US 2024/0252932 A1
(43) Pub. Date: Aug. 1, 2024

(54) Game System, Information Processing Program and Information Processing Method

(71) Applicant: Akatsuki Inc., Tokyo (JP)

(72) Inventor: Qianwen HUANG, Tokyo (JP)

(21) Appl. No.: 18/426,342

(22) Filed: Jan. 30, 2024

(30) Foreign Application Priority Data
Jan. 31, 2023 (JP) 2023-013620

(51) Int. Cl. A63F 13/79; A63F 13/35

(52) U.S. Cl. CPC A63F 13/79; A63F 13/35

(57) ABSTRACT

A game system includes a reception processing, in the game, when executing a processing of granting randomly selected a game media to a player based on a consumption of an in-game consideration, accepting a consumption request of a second consideration as the in-game consideration of a preset n times of a first consideration from the player, a granting processing, when the consumption request of the second consideration is accepted in the reception processing, granting the game media of a quantity based on the n times to the player, executes, wherein, when the consumption request of the second consideration is accepted, the game media granted to the player in the granting processing of the quantity based on the n times are all the same game media.

### TECHNICAL FIELD

The present invention relates to a game system, an information processing program, and an information processing method.

### BACKGROUND TECHNOLOGY

In recent years, it has been provided that a game can be executed on a player terminal such as a smartphone and a game terminal and the like that can access a server via a network. In this type of the game, there is in case of a game media such as a character and an item and the like are randomly provided to a player by a lottery game so-called Gacha.

Patent Document 1 is disclosed the game aims to increase an entertainment by implementing a function that provides a past lottery history for the multiple lottery game, and allows to select the lottery game based on the provided lottery history to the player.

### PRIOR ART LIST

### Patent Document

Patent literature 1: Japanese Unexamined Patent Publication No. 2014-200264

### SUMMARY OF THE INVENTION

### Technical Problem

By the way, in this type of the game, when a game quality of the game (for instance, a fun, a challenge and the like) of the game can be improved by the executed lottery game, it would be assumed that possible to improve an interest of the player, hereby it is desirable that an elaborate function is implemented in the executed lottery game.

The present invention has been made in a view of the above circumstances, and an object is to provide the game system, the information processing device, the information processing program, and the information processing method that can improve the interest of the player.

### Technical Solution

A game system according to the present invention for achieving the above-mentioned problems is, the game system for providing a game can be executed on a player terminal, the game system, a reception processing, in the game, when executing a processing of granting randomly selected a game media to a player based on a consumption of an in-game consideration, accepting a consumption request of a second consideration of a preset n times of a first consideration from the player as the in-game consideration, a granting processing, when the consumption request of the second consideration is accepted in the reception processing, granting all the same game media of a quantity based on the n times to the player, executes is characterized.

According to this, when the second consideration that is the n times for the first consideration is accepted during the lottery game, the same game media of the quantity of the n times is provided, hereby it improves the gameplay and increases the interest of the player can be improved.

The information processing program according to the present invention for achieving the above-mentioned problems is the information processing program for executing the game on the player terminal for being possible to access a server via a network, the information processing program comprises, a reception processing, in the game, when executing a processing of granting randomly selected a game media to a player based on a consumption of an in-game consideration, accepting a consumption request of a second consideration of a preset n times of a first consideration from the player as the in-game consideration, when the consumption request of the second consideration is accepted in the reception processing, granting all the same game media of a quantity based on the n times to the player, executes by the server is characterized.

The information processing method according to the present invention for achieving the above-mentioned problems is the information processing method for executing the game on the player terminal for being possible to access the server via the network, the information processing method comprises, a reception processing, in the game, when executing a processing of granting randomly selected a game media to a player based on a consumption of an in-game consideration, accepting a consumption request of a second consideration of a preset n times of a first consideration from a player as the in-game consideration, when the consumption request of the second consideration is accepted in the reception processing, granting all the same game media of a quantity based on the n times to the player, executes is characterized.

### Advantageous Effects

According to this invention, it is possible to improve the interest of the player in the game.

### BRIEF DESCRIPTION OF THE DRAWING

FIG. 1 is a block diagram for explaining an outline of a configuration of a game system according to an embodiment of the present embodiment.

FIG. 2 is, as same, a block diagram for explaining an outline of a configuration of a server of a game system according to the present embodiment.

FIG. 3 is, as same, a block diagram for explaining an outline of a configuration of a storage of a server in a game system according to the present embodiment.

FIG. 4 is, as same, a block diagram for explaining an outline of a configuration of a game information processed by a game system according to the present embodiment.

FIG. 5 is, as same, a flow chart for explaining an outline of a processing of a second step of an information processing program of a game system according to the present embodiment.

FIG. 6 is, as same, a flow chart for explaining an outline of a processing of a second step of an information processing program of a game system according to the present embodiment.

FIG. 7 is, as same, a block diagram for explaining an outline of a configuration of a player terminal of a game system according to the present embodiment.

### DETAILED DESCRIPTION OF THE EMBODIMENTS

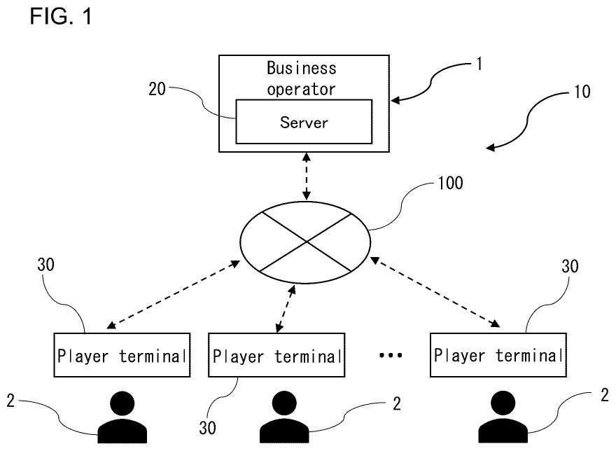

Next, a game system according to an embodiment of the present invention will be described based on FIGS. 1 to 7.

FIG. 1 is a block diagram for explaining an outline of a configuration of the game system according to the embodiment of the present invention. As shown, a game system 10 comprises a server 20 that is an information processing device and a plurality of player terminal 30 such as a main composition, they are connected so as to be accessible to each other via a network 100 such as the Internet network and the like.

The server 20 is, in the present embodiment, deployed to a business operator 1 providing the game on the game system 10, and the player terminal 30 are held by each of the plurality of a player 2 using the game provided by the business operator 1.

The game provided by the business operator 1 on the game system 10 may be, for instance, a competitive game, a puzzle game, an action game, a baseball game, a soccer game, other sports game, a quiz game, a pinball game, a card game, a rhythm game, an RPG (role play games), a location information game, a board game, an adventure game, a casino game, a simulation game, a strategy game, and a racing game and the like.

Next, a specific configuration of each part of the game system 10 of the present embodiment will be described.

The server 20 is, in the present embodiment, implemented by a desktop or a notebook computer.

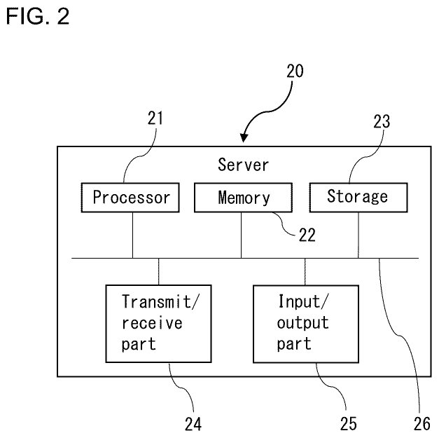

FIG. 2 is the block diagram for explaining the outline of the configuration of the server 20. As shown, the server 20 comprises a processor 21, a memory 22, a storage 23, a transmitting/receiving part 24, and an input/output part 25, they are electrically connected to each other via a bus 26.

The processor 21 is an arithmetic device that controls an operation of the server 20, controls the transmission and reception of a data between each an element, and performs a processing and the like necessary for executing an application program.

The processor 21 is, in the present embodiment, for instance, a CPU (Central Processing Unit), executes an application program stored in the storage 23 described later and developed in the memory 22, performs a various processing.

The memory 22 is, in the present embodiment, implemented as a main memory device consisted in a volatile memory device such as DRAM (Dynamic Random Access Memory) and the like.

This memory 22 is used as a work area of the processor 21, and also stores a BIOS (Basic Input/Output System) executed when the server 20 is starting and a various setting information and the like.

The storage 23 stores a program and an information used in the various processing. The configuration of this storage 23 will be described later.

The transmitting/receiving part 24 connects the server 20 to a network 200. The transmitter/receiver 24 may comprise a short-range communication interface such as Bluetooth (registered trademark) or a BLE (Bluetooth Low Energy).

The input/output part 25 is an interface that an input/output device such as a keyboard, a mouse, or a display and the like are connected.

The bus 26 transmits, for instance, an address signal, a data signal, and a various control signal between the processor 21, the memory 22, the storage 23, the transmitting/receiving part 24, and input/output part 25 that are connected.

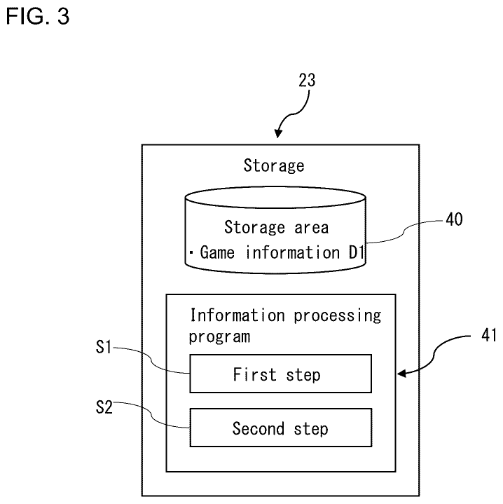

FIG. 3 is the block diagram for explaining the outline of the configuration of the storage 23. As shown, the storage 23 comprises, in the present embodiment, a storage area 40 and an information processing program 41.

The storage area 40 is realized by partitioning the storage 23, and in the present embodiment, a game information D1 is stored therein.

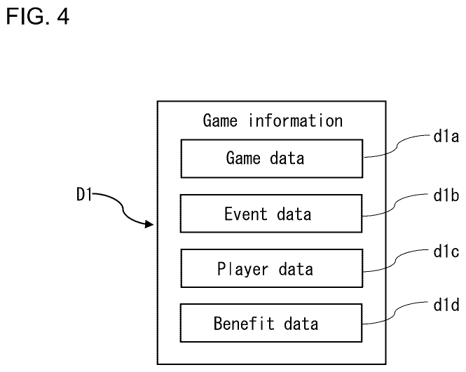

FIG. 4 is the block diagram for explaining the outline of the configuration of the game information D. As shown, the game information D1 comprises a game data d1a, an event data d1b, a player data d1c, and a benefit data d1d.

The game data d1a is, in the present embodiment, an account information logging into the game by the player 2, it is consisted in a game media such as a character, an item, a card and the like that appears in the game, a background image, and the data related to a game setting according to the type of the game, and the like, for instance, in the case of the competitive game, a stage name and the like associated with a stage ID is included. The game media includes the character, the item (including a weapon, an armor and the like), a card or a sticker drawn the character or the item, the card that is possible to execute a spell, a magic, a technique and the like, may also be an element within another game.

The character that is the game medium constituting the game data d1a is, in the present embodiment, includes the character that acts in the game by operated via the player terminal 30 by the player 2, the character that becomes a companion of the player 2, or an enemy character fighting against the player 2 and the like.

The game media constituting the game data d1a is included, in the present embodiment, the item that the player 2 can use in the game.

The event data d1b is included, for instance, it is included that an arbitrary event and the like that is set a trial (for instance, a battle with the enemy character, a lottery game of a limited time and the like) executed by the player 2, When satisfying a condition that this type event is executed or cleared and the like, it may be granted the above-mentioned game media, and an in-game benefit described later that an attack item, a restore item such as a physical strength of the character and the like that used in the game.

The event data d1b includes, in the present embodiment, the data related to a lottery event (including a quest, a training and the like, described later) such as the lottery game (for instance, the so-called Gacha) and the like that randomly provide the game media, The data related to the Gacha includes, for instance, the data related to the in-game consideration required to the player 2 when executing the Gacha. Furthermore, it is not limited to the lottery game such as the Gacha that the process (a lottery process) for granting in-game randomly selected the game media based on the consumption of the in-game consideration to the player, It may be a quest (referred to as a drop and the like) that grants the game media such as the item by advancing the game by consuming the item, or it may also be a breeding process that granting the game media such as the character and the item and the like by training the character based on the consumption of a training item. The data related to the lottery event may include the data related to a coefficient.

The data related to the in-game consideration is, the in-game consideration is paid by an in-game currency such as for instance a “stone (a magic stone)” and the like, hereby it is set variously that “300 stones” when the Gacha is executed a one time, and “3000 stones” and the like, when executing a so-called “10 consecutive Gacha” that a 10 times Gacha is executed continuously (for instance, in one operation). The In-game currency may include a paid currency obtained by charging, and a free currency granted (without charging) according to a various condition (a stage clear, a login, a training and the like) during the game. Note that the in-game consideration is not limited to the in-game currency, it may be an in-game point or the item such as a ticket and the like consumed when performing a various function such as the lottery, the quest, and the training. Moreover, the data related to the in-game consideration can include the data related to the first consideration and the second consideration. Specifically, in the above instance, it may include that the data of “300 stones” that is the first consideration of the Gacha executed the one time (a regular lottery), and “150 stones”, “600 stones”, “3000 stones” and the like that is the second consideration of a consideration of a special gacha (a special lottery) that grants the game media based on the n times of the Gacha executed the one time. In addition, it may include that the data that “3000 stones” that is the first consideration of the 10 consecutive Gacha (a regular consecutive lottery) and “1500 stones”, “6000 stones”, “30000 stones” and the like that is the second consideration that grants the game media based on n times that the consideration by the 10 times consecutive Gacha (the special lottery).

In the present embodiment, an information on the in-game consideration that included in the event data d1b may be set in advance as the “first consideration”, the “second consideration” and the like.

The player data d1c is, in the present embodiment, consisted in the data related to the game media such as, the name in the game, an identification information (ID), a used character and the like that are of the player 2, the data related to the game media and the like that the character owned or used by the player 2, and the data related to a parameter and the like that a stamina and the like that recovers by an overtime and consumed when playing the game, the data related to a play history, a login time, and the login time that is the data and the like related to a play stage. The data related to the stamina may include a current stamina information and an upper limit stamina information. The current stamina information is the information indicating a numerical value of a currently consumable stamina of the player. The upper limit stamina information is indicating the information when the upper limit value of the stamina recovered once the predetermined time has elapsed or in accordance with using the item or a special ability of the character and the like. The player data d1c may include the information related to a limit on a number of a lottery processing described later.

The data related to the game media such as the character and the like owned and used by the player 2 includes, in the present embodiment, the data related to the character and the item, and is included, for instance, a value of a various parameter. Specifically, in association with the ID of each an owned character, it may include that the various parameter such as an acquisition date and time, a character name, a level, a rarity, an HP (a current value/a maximum value), an attribute, a skill, an attack power (the current value/the maximum value), a defense power (the current value/the maximum value) a frequency of using. The acquisition date and time is the information related to the date and the time when the character was given to the player by progressing the game or executing the lottery. The rarity is the information related to, for instance, the winning probability (a probability given) of the character in the lottery game. The HP, the attack power, and the defense power can be included the “current value” that the current value, and the “maximum value” when the character is raised to the maximum level. The attribute includes a classification that indicates a strength of the character, such as a fire attribute, a water attribute, or a wind attribute in a battle-based game, the classification and the like that indicates a team and a position and the like that the character belonging in the sports game, and a setting information related to the other classification of the character. The skill is the information that a special skill and the like that the character can use. The frequency of using is the information related to the frequency that the player selected or used the character in the past. The frequency of using may be calculated for the entire period since the player started the game, or may be calculated for the arbitrary period that the most recent several months. Further, the game media information may include the information related to the owned item in addition to the owned character. The owned item information can include the information that the number of the possessions and the like in association with the ID of the owned item. Note that the server 20 or the player terminal 30 may hold all or part of the various information as a storage part.

The data related to the play stage is the data related to the stages that the player 2 has played in the past among the plurality of stages that have been set, and includes, for instance, the number of times of the played and the data when the stage has been cleared.

The benefit data did is the data related to an in-game benefit given to the player 2.

In the present embodiment, it is included that the data related to the condition for granting the in-game benefit (hereinafter also referred to as a “benefit”) to the player 2, the data related to the granted benefit and the like. The Benefit is not particularly limited as long as they are beneficial to the player in the game, for instance, it may be that granting an in-game content such as the in-game currency and the various item and the like, lifting of the various in-game limit (granting a right for performing the various function), changing (increasing, reducing) the various parameter (the level, an experience point, the stamina, an ability value of the game media, a quantity that can be borrowed in advance), increasing in the upper limit value of the parameter, reducing in the lower limit value of the parameter, recovering of the stamina and the like. In addition, the benefit may be not limited to be in cases of the above content that so as to change an advantage for own player, an ally player, and a friend and the like, but also, may change the above content that so as to make an enemy player disadvantageous. The above content changes that so as to make an enemy player disadvantageous, may be, for instance, the ability value of the enemy player changes to decrease, an attack accuracy of the enemy player changes to decrease, or the enemy character itself changes the character having low ability.

The information processing program 41 shown in FIG. 3 is, in the present embodiment, a program that the server 20 executes a first step S1 and a second step S2.

The first step S1 is, in the present embodiment, a step for executing a basic processing of the game such as progressing the game and controlling the character, and for instance, executes the various processing such as progressing the game and switching a game mode.

The second step S2 executes, in the present embodiment, the processing related to the Gacha that randomly provides the game media to the player by the lottery game according to the consumption of the consideration in the game.

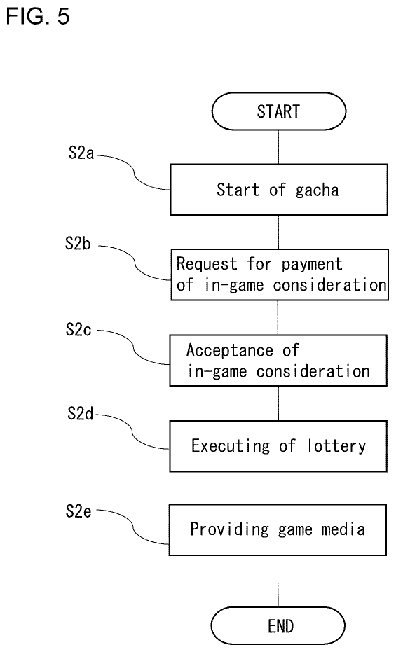

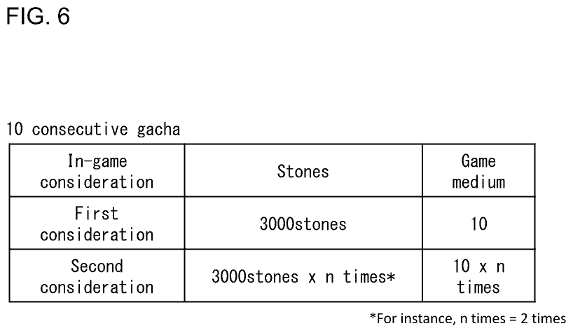

FIG. 5 is a flowchart for explaining the outline of the processing of the second step S2, and FIG. 6 is a diagram for explaining the outline of the processing of the second step S2. As shown in FIG. 5, in the second step S2, the Gacha is started in a step S2a at an arbitrary timing according to, for instance, the progress of the game. The timing starting the Gacha may be a timing input an instruction executing the Gacha by the player, but it is not limited thereto, and may be the preset timing in the game system.

In the following a step S2b, it requests for the player 2 to consume (pay) the first consideration as the in-game consideration via the player terminal 30. In the present embodiment, as shown in FIG. 6, it requests for the player 2 to pay for instance, “3000 stones” of a first consideration as the in-game consideration for executing the so-called “10 consecutive Gacha”. The first consideration is set in advance for each a type of the lottery game, such as a single Gacha that the lottery is held only once, the 10-consecutive Gacha that the 10 consecutive lotteries are drawn as one unit and the like, and can be a standard of each the lottery game. (a standard consideration). Furthermore, the step S2b and a step S2c may be included in the step S2a. In other words, by the player selects to execute the Gacha that the conditions such as the in-game consideration disclosed in advance in the game, up to the reception of the in-game consideration may be executed. In this case, the player may arbitrarily select one of a “standard 10 consecutive Gacha” that is a regular lottery game accepting the first consideration, and a “high risk high return 10 consecutive Gacha” that is a special lottery game accepting the second consideration that the n times (the 2 times) of the first consideration, and the selected type of the 10 consecutive Gacha may be performed in step 2d.

On the other hand, when the player 2 inputs a payment of the first consideration via the player terminal 30, the input of the payment of the first consideration is accepted in the step S2c (acceptance process).

Following the reception processing, the lottery of the Gacha is executed in a step S2d. In the 10 times Gacha of the “10 consecutive Gacha” in the lottery of the Gacha, the 10-game media (for instance, the card, the item and the like) are randomly selected each based on the winning probability.

The 10-game media selected in the step S2d are provided to the player 2 via the player terminal 30 in a step S2e (the granting processing). Note that 10-game media may all be different or may include the same one.

By the way, in the present embodiment, in the step S2c, by inputting the consumption request for the second consideration that is the n times of the first consideration and paying the second consideration, the same game media of the n times of the game media selected in the Gacha can be received to be provided. In other words, for instance, when it pays twice the price in the 10 consecutive Gacha, it will get 2 of each of the randomly (based on the winning probability) 10 selected game media for it can get a total of a 20-game media. Furthermore, for instance, in the case of the Gacha executed the one time instead of the 10 consecutive Gacha, it is possible to obtain that the game media of the n times of the number of a one lottery.

About this second consideration, it may be that a n of the n times is an integer exceeding 1 (for instance, the 2 times, the 3 times, the 4 times and the like), or may be that the n of the n times is the number less than 1 (for instance, the 0.5 times, the 0.6 times and the like). Further, the value of the second consideration (that is, the value of the n) may be arbitrarily set in advance, or may be arbitrarily set according to the condition such as a game situation, a various play history of the player, and a parameter value and the like. When the n of the n times is the number less than 1, for instance, it may exist that getting the 0.5 times of a quantity of the game media, however, by getting the 2 times of the game media that 0.5 times and it gets the game media that the 1 time (or an integral number times), or by generating to the 1 or more, it may be used as an one game medium, or it may be used as the 0.5 game medium alone. When it may be used as the 0.5 game medium alone, for instance, when the 0.5 times game media is used alone, it may be obtained an effect of the 0.5 times of the game media against the (the 1 time) effect of the game media.

In the present embodiment, in response to the consumption request in the step S2b, as shown in FIG. 6, when the player 2 inputs the consumption of the second consideration that the n times (for instance the 2 times) of “3000 stones” as the in-game consideration for executing the “10 consecutive Gacha”, the consumption of the second consideration (“6000 stones”) is accepted in step S2c (reception processing).

Following the reception processing, the Gacha lottery is executed in step S2d.

In the step S2d, the 10 lotteries of the “10 consecutive Gacha” are executed, when the 10-game media (it may be all the different game media or some overlaps) is randomly selected, in step S2e, as shown in FIG. 6, the 2 pieces of each of the 10-game media are given to the player 2 via the player terminal 30, (granting processing). That is, a total 20 of the game media (for instance, a card item and the like) that the number (the 2 times×the 10 pieces) according to the n times the number of the lottery (in this case, the 10 times) is granted.

Note that, only when the player satisfies a specific condition in the game, the reception processing in the step S2c may accept the request for the consumption of the second consideration from the player. For instance, a special lottery game that the game media of the n times that is granted by consuming the second consideration may be executed when the player satisfies the specific condition. Alternatively, when the specific condition is satisfied, the consumption of the second consideration of the specific n times may be selected. For instance, normally it is possible to select the first consideration that is the 1 time and the second consideration (n=2) that is the 2 times, however when the specific condition is satisfied, it may be possible to select the second consideration (n=3) that is the 3 times. Further, after receiving the consumption request of the second consideration from the player, by satisfying the specific condition, it may be possible to execute that the granting processing the game media. Here, the specific condition is not particularly limited as long as it is the condition related to the game, however for instance, it may be possessing or consuming a specific item such as a high-risk Gacha ticket and the like, or it can be the condition related to player data about each the player. Further, the conditions related to the player data may be, specifically, for instance, a preset point in time (a current moment, a specific point in the past) or during a preset period, a progress degree of the game (a reached stage, an acquired item and the like), in case of the value of a preset parameter is above or below a preset threshold. The preset parameter may be, for instance, the value related to the login such as the number of the times of the login and the login time and the like, the value related to the play history such as the number of the times of a play, a play time and the like, the value related to a relationship with another user such as the number of the friend, the number of a cooperative play with the other user and the like, the level in a player game, a rank in the game, the number of owned an in-game currencies, the quantity of a paid charge, a numerical value related to the character (the attack power, the defense power, the physical strength, the level and the like), the number of the owned item, the number of an owned character, the number of the consumed stamina, the value of a current stamina, the number of the times of executing the preset lottery game and the like. The specific item such as the high-risk Gacha ticket and the like are granted to the player in the game by clearing a preset stage of the game, the paid change, purchasing by the in-game currency and the like. The specific condition may be satisfying of any one of the above conditions, or may be a combination of the multiple condition.

Furthermore, in the present embodiment, it may be existing the limit that the number of the times of the lottery processing based on the consumption of the second consideration can be executed. For instance, an upper limit of the number of executing may be set such as the 1 time, the 10 times, the 20 times and the like within a preset period such as a 1 hour, a 1 day, a 1 week, a 1 month and the like. The Information related to the upper limit is stored in the storage part. Such the limit may be common to all the player, or may be set for each the player. Further, the limit may be a constant or may vary based on the player data and the like. For instance, when the above-mentioned specific condition is satisfied, the limit of the number of the times may be relaxed (that is, the number of the times that can be executed in the preset period is increased). Alternatively, when the above-mentioned specific condition is not satisfied, the limit of the number of the times may be made stricter (that is, the number of the times that can be executed in the preset period is reduced).

Based on the processing in the first step S1 and the second step S2, in the present embodiment, the game is executed on the player terminal 30.

The player terminal 30 shown in the FIG. 1 is, in the present embodiment, implemented a smartphone that is a portable information terminal, however, it may also be implemented, for instance, by a game-dedicated terminal, a tablet computer, a desktop computer, or a notebook computer.

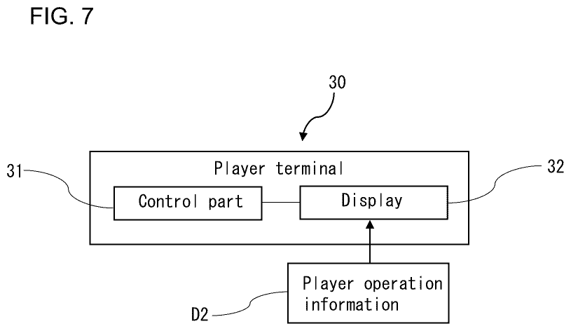

FIG. 7 is the block diagram for explaining the outline of the configuration of the player terminal 30. As shown, the player terminal 30 comprises a control part 31 and a display 32 as main components.

The control part 31 controls, in the present embodiment, a various part of the player terminal 30, such as the display 32 and a not shown camera and the like, and consisted in, for instance, a processor, a memory, a storage, a transmitting/receiving part and the like.

This control part 31 stores, in the present embodiment, a game application or a browser that can view a website, based on the processing by the information processing program 41 of the server 20, the game is executed via the game application or the browser on the player terminal 30.

The display 32 displays, in the present embodiment, a screen interface and the like of executed the game on the player terminal 30.

This display 32 is a so-called touch panel that accepts the information input by touching the display surface, and is implemented using a various technology such as a resistive film method and a capacitive method.

In the present embodiment, a player operation information D2 is input via this display 32.

The player operation information D2 is, in the present embodiment, the information input related to the operation and the movement of the character used by the player 2 in the game, or the information input related to a various setting and a utility management related to the game.

This player operation information D2 is input based on an arbitrary action (for instance, an action such as a tapping, a double-tapping, a long-tapping, a sliding, or a swiping the screen, or the action such as a dragging and a dropping an icon displayed on the screen and the like) by the player 2 on the display 32.

In such the game system 10, when the player 2 progresses the game by executing the game on the player terminal 30, the Gacha is started at an arbitrary timing according to the progress of the game.

About starting of the Gacha, when the player 2 inputs, as the in-game consideration, the consumption of the first consideration or the second consideration, and an inputting is accepted, a lottery of the Gacha is executed, and the game media of the number according to the input first consideration or the second consideration, is provided to the player 2 via the player terminal 30.

In the present embodiment, when the second consideration that is the n times against the first consideration is received, the same game media of the quantity based on n times on the second consideration is provided, hereby, the game quality is improved by the Gacha and the interest of the player 2 can be increased. Here, the quantity based on the n times may be the quantity of the n times. In that case, for instance, when the second consideration is twice of the first consideration, the same game media of the number of twice is granted. Moreover, the quantity based on the n times may be the quantity obtained by multiplying the n by a preset coefficient. The coefficient may be greater than or equal to 1 or less than 1, and is stored in advance in a storage part. The coefficient may vary for each the player according to each the player data, or may be a constant. For example, in case of the preset coefficient is 1.5, when the second consideration that is twice of the first consideration is consumed, it is granted to the player that the randomly selected specific game medium (the same game medium) of 3 that “2” that is the value of the n is multiplied by the coefficient of “1.5”. Further, for instance, in case of the preset coefficient is 0.5, when the second consideration that is four times of the first consideration is consumed, it is granted to the player that the randomly selected specific game medium (the same game medium) of 2 that “4” that is the value of the n is multiplied by the coefficient of “1.5”. Note that the method for calculating such the quantity is not limited to multiply by the coefficient, and may be an arbitrary calculation method such as adding, subtracting, or dividing the preset number.

In particular, in the present embodiment, when the n times on the second consideration is an integer multiple, it is increasing that a risk that the consumption of the in-game consideration on the Gacha will be a high price, however, when the game media with a high rarity is selected on the Gacha, it is existing a great return that the provided game media that will be increasing the n times.

On the other hand, when the n of the n times on the second consideration is the number less than 1, it is decreasing the risk by the consumption of the in-game consideration on the Gacha will be reduced, however, when the game media with the high rarity is won on the Gacha, it becomes a smaller return by the provided quantity will be the number according to the n times.

In this way, it is expected that the interest of the player will be further improved by arbitrarily executing the high-risk high-return Gacha or a low-risk low-return Gacha.

Note that the present invention is not limited to the above embodiment, and a various change can be made without departing from the spirit of the invention.

In the above embodiment, at starting the Gacha, a case has been described that inputting of the consumption of the first consideration as the in-game consideration is required, however, for instance, it may be a selection between the first consideration and the second consideration is requested, alternatively, it may be a suggestion to input the consumption of the second consideration.

In the above embodiment, the case has been described that the information processing program 41 stored in the server 20 executes the information processing related to the game on the player terminal 30, however, it may be configured such that a part or an all of the information processing program 41 is stored in the player terminal 30 and this the information processing program 41 executes the information processing related to the game on the player terminal 30. In this case, in this system, only each player terminal (an information processing terminal) may excuse all the information processing without providing a server.

The present invention comprises the following configuration.

### (Item 1)

A game system for providing a game can be executed on a player terminal,

the game system comprises:

a reception processing, in the game, when executing a processing of granting randomly selected a game media to a player based on a consumption of an in-game consideration, accepting a consumption request of a second consideration of a preset n times of a first consideration from the player as the in-game consideration;

a granting processing, when the consumption request of the second consideration is accepted in the reception processing, granting the game media of a quantity based on the n times to the player;

executes,

wherein, when the consumption request of the second consideration is accepted, the game media granted to the player in the granting processing of the quantity based on the n times are all the same game media.

### (Item 2)

The game system according to item 1,

wherein the second consideration is

a n of the n times is an integer exceeding 1 is characterized.

### (Item 3)

The game system according to one of the items 1 or 2,

wherein the second consideration is

the n of the n times is a number less than 1 is characterized.

### (Item 4)

The game system according to one of the items 1 to 3,

wherein, the reception process is,

only when the player satisfies a specific condition in the game, accepting the consumption request of the second consideration from the player is characterized.

### (Item 5)

The game system according to one of the items 1 to 4,

wherein, the quantity based on the n times is the quantity multiplied by the n times is characterized.

### (Item 6)

The game system according to one of the items 1 to 5,

wherein, the quantity based on the n times is the quantity multiplied the n by a preset coefficient is characterized.

### (Item 7)

An information processing program for executing a game on a player terminal for being possible to access a server via a network,

the information processing program comprises:

a reception processing, in the game, when executing a processing of granting randomly selected a game media to a player based on a consumption of an in-game consideration, accepting a consumption request of a second consideration of a preset n times of a first consideration from the player as the in-game consideration;

a granting processing, when the consumption request of the second consideration is accepted in the reception processing, granting the same game media of a quantity based on the n times to the player;

executes by the server,

wherein, when the consumption request of the second consideration is accepted, the game media granted to the player in the granting processing of the quantity based on the n times in the granting processing are all the same game media.

### (Item 8)

An information processing method for executing a game on a player terminal for being possible to access a server via a network,

the information processing method comprises:

a reception processing, in the game, when executing a processing of granting randomly selected a game media to a player based on a consumption of an in-game consideration, accepting a consumption request of a second consideration of a preset n times of a first consideration from a player as the in-game consideration;

a granting processing, when the consumption request of the second consideration is accepted in the reception processing, granting a quantity based on the n times, the same game media to the player;

executes,

wherein, when the consumption request of the second consideration is accepted, the game media granted to the player in the granting processing of the quantity based on the n times are all the same game media.

### DESCRIPTION OF THE REFERENCE NUMERALS

1 Business operator
2 Player
10 Game system
20 Server
30 Player terminal
40 Storage area
41 Information processing program

1. A game system for providing a game can be executed on a player terminal,
the game system comprises:
a reception processing, in the game, when executing a processing of granting randomly selected a game media to a player based on a consumption of an in-game consideration, accepting a consumption request of a second consideration of a preset n times of a first consideration from the player as the in-game consideration;
a granting processing, when the consumption request of the second consideration is accepted in the reception processing, granting the game media of a quantity based on the n times to the player;
executes,
wherein, when the consumption request of the second consideration is accepted, the game media granted to the player in the granting processing of the quantity based on the n times are all the same game media.

2. The game system according to claim 1,
wherein the second consideration is
a n of the n times is an integer exceeding 1 is characterized.

3. The game system according to claim 1,
wherein the second consideration is
the n of the n times is a number less than 1 is characterized.

4. The game system according to claim 1,
wherein, the reception process is,
only when the player satisfies a specific condition in the game, accepting the consumption request of the second consideration from the player is characterized.

5. The game system according to claim 1,
wherein, the quantity based on the n times is the quantity multiplied by the n times is characterized.

6. The game system according to claim 1,
wherein, the quantity based on the n times is the quantity multiplied the n by a preset coefficient is characterized.

7. An information processing program for executing a game on a player terminal for being possible to access a server via a network,
the information processing program comprises:
a reception processing, in the game, when executing a processing of granting randomly selected a game media to a player based on a consumption of an in-game consideration, accepting a consumption request of a second consideration of a preset n times of a first consideration from the player as the in-game consideration;
a granting processing, when the consumption request of the second consideration is accepted in the reception processing, granting the same game media of a quantity based on the n times to the player;
executes by the server,
wherein, when the consumption request of the second consideration is accepted, the game media granted to the player in the granting processing of the quantity based on the n times in the granting processing are all the same game media.

8. An information processing method for executing a game on a player terminal for being possible to access a server via a network,
the information processing method comprises:
a reception processing, in the game, when executing a processing of granting randomly selected a game media to a player based on a consumption of an in-game consideration, accepting a consumption request of a second consideration of a preset n times of a first consideration from a player as the in-game consideration;
a granting processing, when the consumption request of the second consideration is accepted in the reception processing, granting a quantity based on the n times, the same game media to the player;
executes,
wherein, when the consumption request of the second consideration is accepted, the game media granted to the player in the granting processing of the quantity based on the n times are all the same game media.
